(19) United States
(12) Patent Application Publication
(10) Pub. No.: US 2007/0011279 A1
(43) Pub. Date: Jan. 11, 2007

(54) System and method for providing and displaying multimedia content in correlation with music files in an audio disc

(76) Inventor: Eliram Haklai, Ramat Gan (IL)

Correspondence Address: LATHROP & GAGE LC, 2345 GRAND AVENUE, SUITE 2800, KANSAS CITY, MO, 64108, US

(21) Appl. No.: 11/371,252

(22) Filed: Mar. 8, 2006

Related U.S. Application Data
(60) Provisional application No. 60/661,493, filed on Mar. 15, 2005.

(51) Int. Cl. G06F 15/16

(52) U.S. Cl. 709/219

(57) ABSTRACT

A multimedia enrichment system utilizes data associated with a multi-media record to retrieve data and/or data objects. The retrieved data and/or data objects are correlated with the multi-media record, to be readable with the multi-media record.

### RELATED APPLICATIONS

This application claims priority to U.S. Provisional Application Ser. No. 60/661,493, filed Mar. 15, 2005 which is incorporated herein by reference.

### FIELD OF THE DISCLOSED TECHNIQUE

The disclosed technique relates to multimedia in general, and to methods and systems for providing visual information related to an audio disc and other audio sources, in particular.

### BACKGROUND OF THE INVENTION

While live music concerts offers a full musical experience to audiences, recorded music initially had to settle for adding printed material to the albums. Adding visual content to audio products has always been an integral part of the selling strategy of such products. Vinyl Records were sold along with album art, lyrics and other printed material. Compact discs (CD) productions utilize various packaging solutions to provide similar and additional printed material. Music Videos provide full and rich visual content that accompanies the music. Several CD-playing software display CD-specific information such as CD and Song titles, cover image, genre, or artist discography. Other players introduced visual interpretations derived from audio frequency, pitch or other audio related parameters. All of these methods lack interactivity. Enhanced CDs introduced CD-ROM content along with the audio on the same CD. Some enhanced CD software included custom-made CD player software for each specific CD. CD Playing software enabled music playback on personal computer CD-ROMs.

Online services such as GraceNote CDDB provided online database access to general information about the album being played in any given CD playing software. DVD format is capable of displaying video clips with some limited interactive content.

The major shortcomings of all of the above mentioned methods is that they all lack a full interactivity feature and do not allow end users to contribute music-inspired material of their own and distribute them without making copyright violations. There is therefore a need for a system and a method for providing such capacities.

### SUMMARY OF THE DISCLOSED TECHNIQUE

The present invention provides methods and systems for reproducing multimedia content in correlation with music files in an audio disc.

In accordance with the disclosed technique, there is thus provided a multimedia enrichment system for reproducing multimedia content in correlation with music files in an audio disc. The system includes at least one client node and a web server. The client node includes an audio player and an audio media reader. The web server includes a multi-media database, a server communication interface, and a client software application. The client software application includes an audio streams authenticator, a multi-media reproducer, and a client communication interface. The multi-media database includes a plurality of multi-media records. Each of the multi-media records includes multi-media content associated with respective multi-media information.

The audio media reader is coupled with an interchangeable media. The server communication interface is coupled with the multi-media database. The audio streams authenticator is coupled with the audio media reader. The client communication interface is coupled with the audio streams authenticator, the audio media reader and with the network.

The audio media reader retrieves audio streams and audio information from the interchangeable media. The audio streams authenticator authenticates the audio streams retrieved by the audio media reader. The client communication interface transmits multi-media information received from the audio media reader to the web server. The client communication interface receives multi-media content retrieved according to the multi-media information from the web server. The client communication interface provides the retrieved multi-media content to the multi-media reproducer. The multi-media reproducer reproduces multi-media content received from the web server to the user.

In accordance with another aspect of the disclosed technique, there is thus provided a method for reproducing multimedia content related to audio files in an interchangeable media. The method includes the procedures of retrieving audio information from the interchangeable media, and determining authenticity of the audio stream according to the audio information. The method further includes the procedures of retrieving the multimedia content from a database, and reproducing the multimedia content in synchrony with the audio stream. The audio information is associated with the audio stream. The audio information includes authentication information respective of the audio stream. The multimedia content is reproduced only if the audio stream is determined to be authentic.

### BRIEF DESCRIPTION OF THE DRAWINGS

The disclosed technique will be understood and appreciated more fully from the following detailed description taken in conjunction with the drawings in which:

FIG. 1 is a schematic illustration of a graphic user interface (GUI) of the client software application, constructed and operative according to an embodiment of the disclosed technique;

FIG. 2 is a schematic illustration of a second GUI of the client software application, constructed and operative according to another embodiment of the disclosed technique;

FIG. 3 is a schematic illustration of a method for operating the system of FIG. 6, operative according to a further embodiment of the disclosed technique;

FIG. 4 is a schematic illustration of a block diagram illustration of the communication process between the web server and the client node for a new end user, operative according to another embodiment of the disclosed technique;

FIG. 5 is a schematic illustration of a block diagram of the flow of information when an end user plays a new CD, according to a further embodiment of the disclosed technique;

FIG. 6 is a schematic illustration of a network system, constructed and operative in accordance with another embodiment of the disclosed technique; and

FIG. 7 is a schematic illustration of a method for adding multimedia content to audio files, operative in accordance with a further preferred embodiment of the disclosed technique.

### DETAILED DESCRIPTION OF PREFERRED EMBODIMENTS

The disclosed technique overcomes the disadvantages of the prior art by providing a client computer graphical content related to audio content of a compact disc (CD), on-line, after confirming that the copy of the CD which is simultaneously played in the computer, is produced according to copyright laws.

The term “reproduce” herein below refers to the action of presenting multimedia content to a user (e.g., playing music, displaying visual content, producing smells and odors, affecting the senses of taste and touch, and the like). The term “playlist” herein below, refers to a list of audio tracks available on an audio CD. The term “ordered playback” herein below, refers to a sequential playback of the audio tracks of the CD. The term “random playback” herein below refers to a playback of the audio tracks in a random order (i.e., shuffled mode). The term “smart intro” herein below refers to a sample from each audio track. The term “track name” herein below refers to the name of each of the audio tracks. The term “track time” herein below refers to the length of each of the audio tracks. The term “plugin” herein below refers to a module which can be added to a client software, to provide additional features and functionality to the client software. The term “multimedia content” herein below refers to an animation running in a loop, informational content, video clip, a music related game, and the like. The term “clip” herein below refers to an animation clip which relates to a specific audio track. The clip is timed and synchronized with the audio track.

The term “video” herein below refers to a video clip which relates to a specific audio track. A user of the disclosed technique can download or view the video using streaming technologies. The term “sing-along” herein below refers to a timed, karaoke style display of one or two lines from the lyrics of the current audio track which are heard at any given moment. The sing-along display can use a bouncing ball, highlighted words or similar methods to point to each word as it is sung. The term “pop-up” herein below refers to a timed display of textual information that appears when an audio track is played. The text appears within a graphic frame with optional animation sequences. The term “playback timecode” herein below refers to the display playback time information (e.g., current time within the track, time left until the end of the track and time left until the end of the audio CD). The term “playhead pointer” herein below refers to an optional animated indication on the current playback time position in the current track. The term “CD ID” herein below refers to a special identification string embedded on every audio CD. The term “audio track” herein below refers to a single track of an audio CD, usually one song. The term “official content” herein below refers to multimedia content provided by the copyright owners. The term “unofficial content” herein below refers to multimedia content provided by independent content creators who do not own copyright to the audio track to which the multimedia content relates.

The disclosed technique provides direct post-sales marketing access to music customers. The disclosed technique also provides enhanced interactive multimedia experience for the users of a system constructed according to the disclosed technique. The disclosed technique supports multiple types of multimedia content, such as video clips, animation, games and textual information, and assigns the multimedia content to the proper audio track with precise timing.

Using the disclosed technique provides a system which allows animation artists, graphic designers and programmers to give their interpretation to any musical segment available on an audio CD. Only the owners of a particular CD can view the multimedia content relating to that CD, so no violation of copyright laws occurs. Each audio track can receive more than one animation. End users have access to both official content, and to unofficial content. In addition, an end user of a system constructed according to the disclosed technique can get offers related to her personal audio collection.

The system includes a client CD player software application, a multimedia database located on a web server, a user database, and a website. The system enables addition of multimedia content to audio CDs or other audio format (e.g., downloadable authorized audio files). The client software application of a system, constructed according to the disclosed technique, can operate on a desktop computer, game console, mobile devices, cellular phones, and the like. The client software application reproduces content in accordance with the audio track as it is played. A user of the client software application can download and update content from the web. The client software application displays a list of available official and unofficial content respective of the audio CD currently playing. A user of the client software application can rate the content, while viewing it. Independent content creators can add unofficial multimedia content to the multimedia database which holds the multimedia content and data. An independent content creator needs to register as content creator before adding unofficial content, and install the tools of the system constructed according to the disclosed technique. The independent content creator can see the accumulated data and statistics of rating about her multimedia content. The independent content creator can create animations, games, graphics, and the like. An independent content creator can contribute remarks, associations and information about a particular audio track by adding pop-up information channel. The multimedia content can include video clips, animation, games, textual information, and the like. The games are specially adapted to suit the characteristics of a specific audio CD in terms of the nature of the music (e.g., energetic versus serene music), the length of each track, and the like. The game is synchronized with the progress of the tracks on the audio CD. The music of the audio CD is the background music of the game.

The web site of the system provides news, software downloads and updates, information about the system and community facilities such as forums, chats, and the like. Registered independent content creator can access an area for independent creators. The creators area offers management tools for creating multimedia content, in the format of the disclosed technique, and review such content, created by other independent creators. Registered creators only create multimedia content respective of an original authenticated audio track to avoid infringement of copyright laws, or other media oriented intellectual property rights. Moderators get access to the tools of the creators, in an area of moderators, for reviewing and authorizing content sent by independent creators.

Information respective of an audio CD, in the multimedia database, can include CD details, track titles, lyrics, image files, background image, CD cover images, and the like. The chords for each CD track are also available. The disclosed technique specifies a default way to play each chord on a guitar, as well as skin images for several visual representations of a guitar, or other musical instruments. Also available are different skins for the animated playhead pointer and for the pop-ups. Each item of the official content available has its own version number. A user of the software application can download an update for the official content item when a new version is available.

According to another aspect of the disclosed technique, the software application includes a module for creating an animation of a singing character. The singing character is synchronized with the actual singing in the audio track using still images. The animation is based on the sing-along timing of the specific audio track. An analysis of each word in the text of the song provides an estimation of timing for the animation, to provide the illusion of a singing character. The sing-along data holds the timing for the beginning of a word or a syllable. Analyzing the timing for the closest word to the current timing as well as the timing for the previous and next words, allows calculation for the proper animation position of the mouth of the character or other animated feature.

According to a further aspect of the disclosed technique, a system for previewing the CD audio tracks is available. Most CD players, in the market, have an “intro” option that plays a short portion of each audio track—usually the first 10 seconds of each audio track, or 20 seconds starting 50 seconds into the track (e.g., 0:50 to 1:10 mm:ss). The preview system can assign audio sections, selected in advance by an official or an unofficial content creator. The audio sections selected for each audio track are played, when the smart intro option is selected. This gives the end user a clear and precise preview of the CD, by playing only the true highlights of each audio track. If smart intro information is not available for the specific CD, then the preview system reverts to an automatic (e.g., fixed or differential) intro selection, based on the length of each audio track.

Much like sing-along, the disclosed technique offers guitar players a way to play along with their favorite music, by dynamically displaying chords along with the current audio track. A master chord key file specifies the most common chords fingering. The master chord key file allows specifying different fingering, for additional or existing chords in each timed chords file, on the multimedia database. The chords file specifies which chords are played and when. The GUI of the client software application displays a graphic representation of the chord fingering and supports various skins.

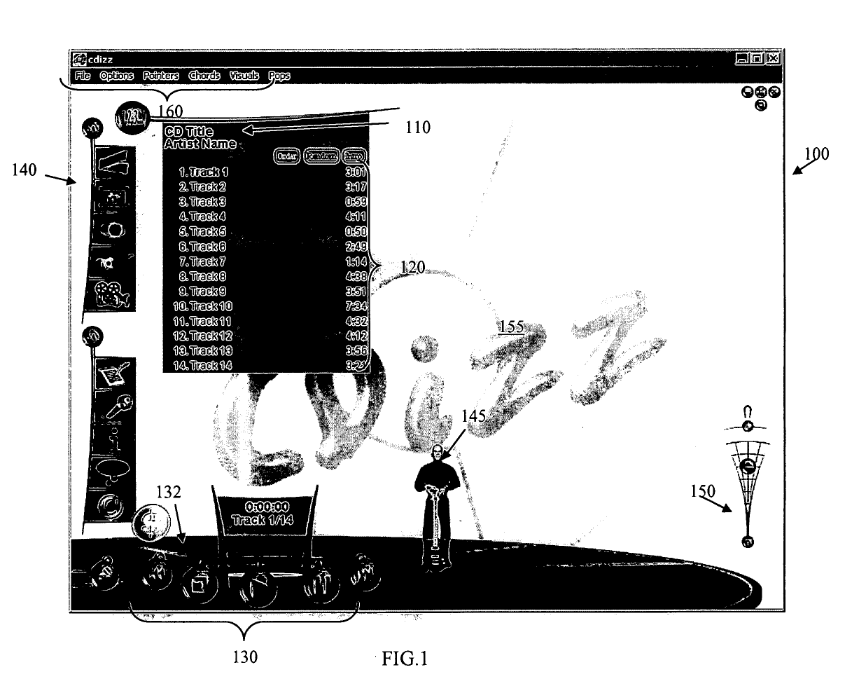

Reference is now made to FIG. 1, which is a schematic illustration of a graphic user interface (GUI) of the client software application generally referenced 100, constructed and operative according to an embodiment of the disclosed technique. GUI 100 includes a CD name field 110, a playlist 120, a display of the playback controls 130, a plugin list 140, a playhead pointer 145, a volume control 150, a background image 155 and a program menu 160. CD name field 110 is not showing the name of a CD when it cannot retrieve the name of the CD. Playlist 120 shows the fourteen audio tracks of the CD, and playback controls 130 are currently in a STOP mode 132. Plugin list 140 displays icons representing the currently available plugins.

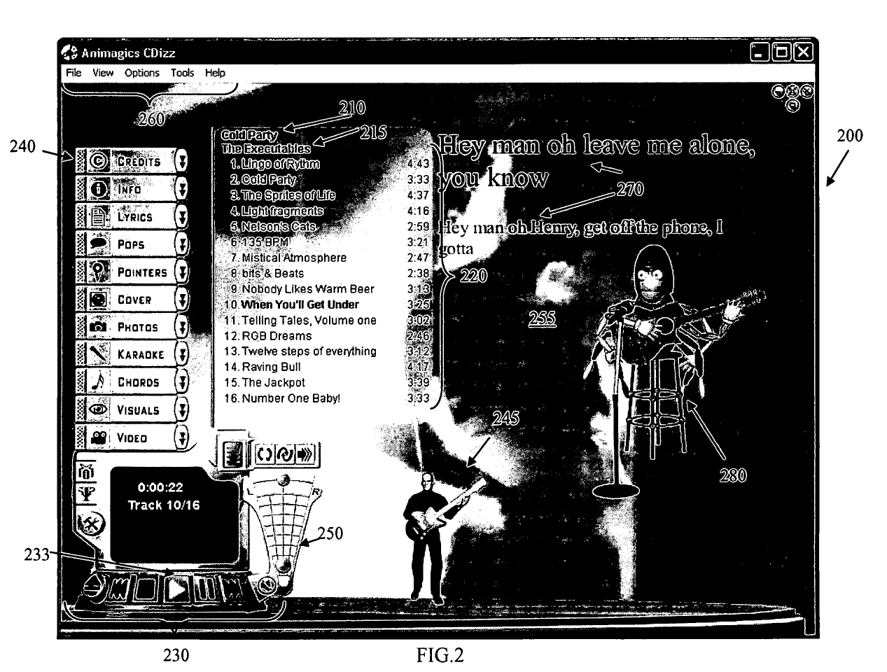

Reference is now made to FIG. 2, which is a schematic illustration of a second GUI of the client software application generally referenced 200 constructed and operative according to another embodiment of the disclosed technique. GUI 200 Includes a CD name field 210, an artist name field 215, a playlist 220, a display of playback controls 230, a plugin list 240, a playhead pointer 245, a volume control 250, a background image 255, a program menu 260, a sing-along option 270 and a visual animation option 280. CD name field 210 holds the name of the CD (e.g., cold party) and artist name field 215 holds the name of the band (e.g., the executables). Playlist 220 shows sixteen audio tracks, and playback controls 230 are currently in play mode 233. An application of custom background 255 is displaying a background chosen by the end user (not shown). Plugin list 240 displays buttons representing the available plugins. An application of karaoke or sing-along option 270 is displaying the text of the audio track currently played. Visual animation option 280 is displaying a singing and playing animated character.

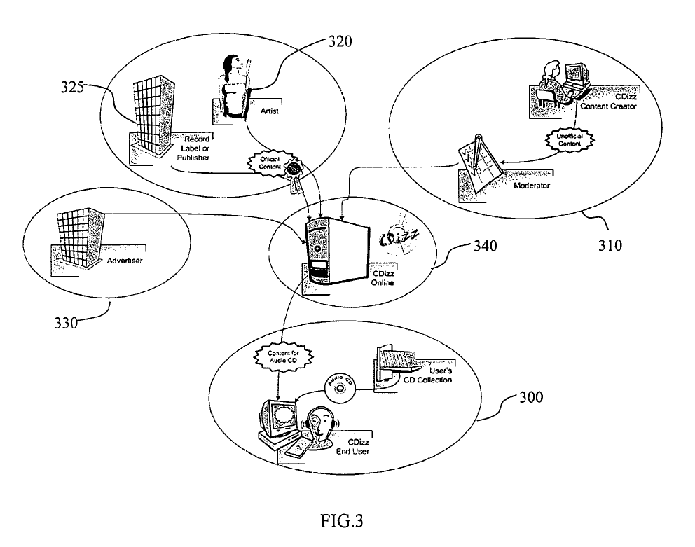

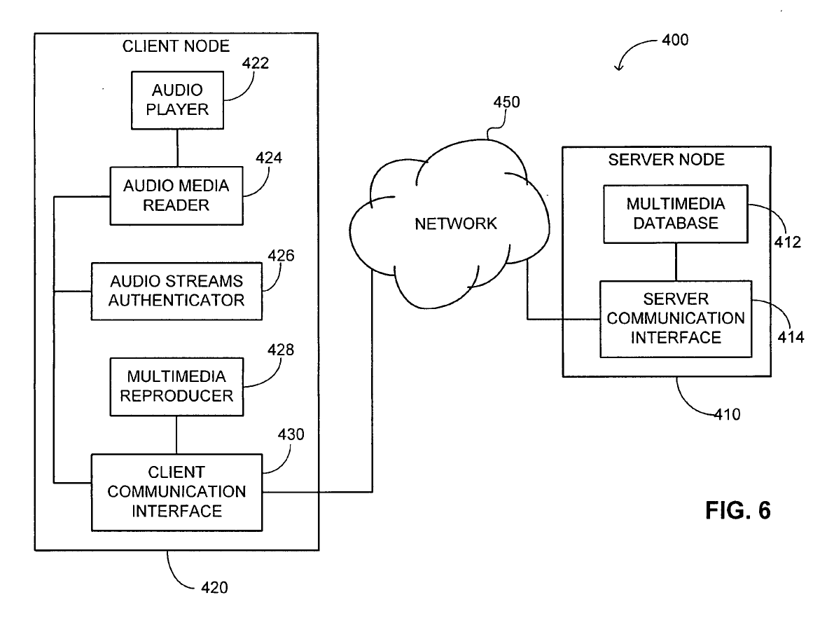

Reference is now made to FIG. 3, which is a schematic illustration of a method for operating the system of FIG. 6 operative according to a further embodiment of the disclosed technique. The method includes an end user 300 of the client software application (not shown), an independent content creator 310, a music artist 320, a record label 325, an advertiser 330 and a web server 340. Several sources can produce content for a given CD. Music artist 320 provides self owned copyrighted content, publicity photos, video clip, text, chords, and the like. Record label 325 provides content similar to the content of artist 320.

Independent content creator 310 can create her own original content and upload the content to web server 340. A moderator reviews content created by independent creators prior to the content incorporation into web server 340. Advertiser 330 can integrate advertisements into the content of the client respective of the current audio CD and the personal collection of user 300. End user 300 selects content from the available content on web server 340, for audio CD, or specific audio track. The sources mentioned above (i.e., official and unofficial content creators) can add content to new or existing audio CD. The official, as well as the unofficial, content providers receive information about the popularity of their contents, and the rating of end users 300.

Web server 340 assigns a unique ID for each customer. Web server 340 holds records of information about the requests of clients. End user 300 can register in order to receive additional benefits (e.g., bonus content not available for unregistered end user 300). The music industry (not shown) can utilize the information about end user 300 to address post sales customers with segmentation capabilities.

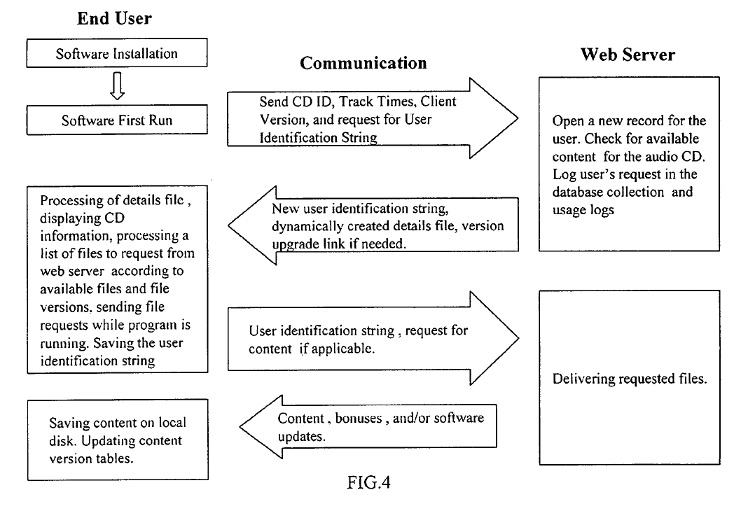

Reference is now made to FIG. 4, which is a schematic illustration of a block diagram illustration of the communication process between the web server and the client node for a new end user, operative according to another embodiment of the disclosed technique. When a client application software is installed for the first time, it tries to access the web server and asks for a new user ID string which will be used to identify the end user in the following sessions. If an audio CD is present, the client node sends the CD ID number as well as other information required to determine which CD is being played.

The web server creates a new account for the end user. The server provides the new user Identification String, along with a list of the available content for the audio CD and basic information on the CD. The client node requests additional files until all the available content is downloaded and up to date. Bonuses are sent to the client node according to relevance to the audio CD being played, priority and volume of bonuses already sent. Clips are sent on demand once the end user selects a clip for downloading. Additional Bonuses may also be downloaded on demand.

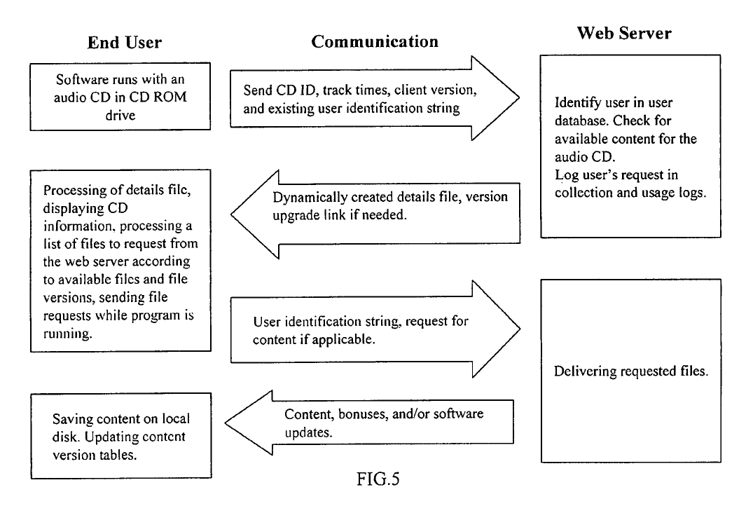

Reference is now made to FIG. 5, which is a schematic illustration of a block diagram of the flow of information when an end user plays a new CD, operative according to a further embodiment of the disclosed technique. The client application of the end user sends the CD ID number to the web server, as well as additional information which is required to determine which CD is being played. The server provides a list of the available contents for the audio CD and basic information about the CD. The client node checks which content files are available locally and are up to date, and requests the missing or updated files from the web server. Multimedia content is sent on demand once the end user selects it for downloading. Bonuses are sent to the client node according to relevance to the audio CD being played, priority and volume of bonuses already sent. Additional bonuses may also be downloaded on demand.

Reference is now made to FIG. 6, which is a schematic illustration of a network system 400 for providing and reproducing multimedia content in correlation with music files, constructed and operative in accordance with another embodiment of the disclosed technique. Network system 400 includes a server node 410 and a client node 420. Server node 410 includes a multimedia database 412, and a server communication interface 414. Client node 420 includes an audio player 422, an audio media reader 424, an audio streams authenticator 426, a multimedia reproducer 428, and a client communication interface 430.

Multimedia database 412 is coupled with server communication interface 414. Audio media reader 424 is coupled with audio streams authenticator 426 and with client communication interface 430. Audio media reader 424 is coupled with audio player 422. Client communication interface 430 is coupled with multimedia reproducer 428. Client communication interface 430 and server communication interface 414 are coupled there between, via a network 450.

Audio media reader 424, containing interchangeable media (e.g., CD, a memory containing audio files), retrieves audio streams (e.g., songs, musical tracks) and audio information corresponding to these audio streams (e.g., singer name, album name, track length) from the interchangeable media. The retrieved audio information includes authentication information (e.g., CD ID). Audio streams authenticator 426 determines the authenticity of the audio streams, according to the authentication information included in the retrieved audio information (e.g., by confirming an identification representation corresponding to the interchangeable media or to the audio information).

Server communication interface 414 retrieves multimedia contents (i.e., audio content, visual content), associated with the audio information. Server communication interface 414 transmits the associated multimedia contents to client node 420. Client communication interface 430 receives the transmitted multimedia content from server node 410. Multimedia reproducer 428 reproduces the received multimedia content in conjunction with audio player 422 playing back the audio streams retrieved by audio media reader 424. It is noted that server node 410 can further include a user database (not shown) for commercial purposes such as advertising segmentation.

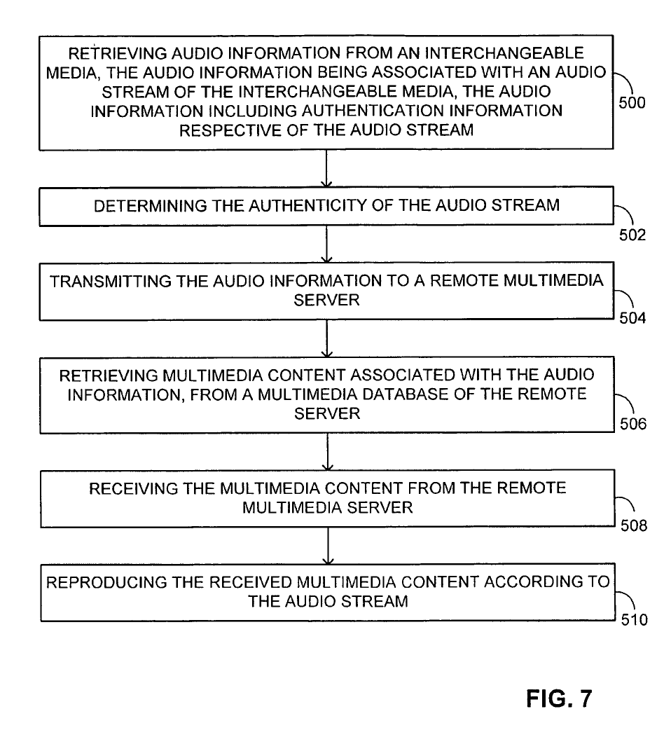

Reference is now made to FIG. 7, which is a schematic illustration of a method for operating the system of FIG. 6 operative according to a further embodiment of the disclosed technique. In procedure 500, audio information and audio streams are retrieved from an interchangeable media. With reference to FIG. 6, audio media reader 424 retrieves audio information from the interchangeable media. The audio information corresponds to the audio streams. The audio information includes authentication information of the corresponding audio streams. The interchangeable media (e.g., CD, Disk On Key) contains songs, musical tracks, and the like. The audio information can be respective of a singer, a group, a record, a total length of the record, length of tracks in the record, and the like. The authentication information (e.g., CD ID) provides a proof for the authenticity of the audio streams stored in the interchangeable media.

In procedure 502, the authenticity of the audio streams, retrieved from the interchangeable media, is determined. With reference to FIG. 6, audio streams authenticator 206 determines the authenticity of the audio streams according to the authentication information included in the corresponding audio information.

In procedure 504, the audio information, retrieved from the interchangeable media, is transmitted to the remote multimedia server. With reference to FIG. 6 client communication interface 430 transmits the audio information to server node 410.

In procedure 506, multimedia contents, associated with the audio information, are retrieved by client node from server node. With reference to FIG. 6, server communication interface 414 retrieves multimedia content, associated with the audio information. Server communication interface 414 transmits the associated multimedia contents to client node 420.

In procedure 508, multimedia content, associated with the audio information, is received from the remote multimedia server. With reference to FIG. 6, client node 420 receives the multimedia content from server communication interface 414.

In procedure 510, the multimedia contents received from the multimedia server are reproduced while the retrieved audio streams are played back. With reference to FIG. 6, client communication interface 430 receives the associated multimedia content from server node 410. Multimedia reproducer 428 reproduces the multimedia content while audio player 422 plays back the retrieved audio streams.

It will be appreciated by persons skilled in the art that the present disclosed technique is not limited to what has been particularly shown and described hereinabove. Rather the scope of the present disclosed technique is defined only by the claims, which follow.

We claim:

1. In a network configuration including at least one client node, coupled with a communication network, the client node including an audio player and an audio media reader, the audio media reader retrieving audio streams and audio information from an interchangeable media coupled therewith, a multimedia enrichment system comprising:
web server including:
multi-media database containing a plurality of multi-media records, each said multi-media record including multi-media content associated with respective multi-media information; and
a server communication interface coupled with said multi-media database; and
a client software application including;
an audio streams authenticator, coupled with said audio media reader, for authenticating said audio streams;
a multi-media reproducer for reproducing to said user, multi-media content received from said web server; and
a client communication interface, coupled with said audio streams authenticator, said audio media reader and with said network, for communicating with said web server, said client communication interface transmitting multi-media information received from said audio media reader to said web server, said client communication interface receiving multi-media content retrieved according to said multi-media information from said web server, said client communication interface providing said retrieved multi-media content to said multi-media reproducer.

2. The multimedia enrichment system according to claim 1, further comprising a user database coupled with said server communication interface, for making a record of all audio streams retrieved by a user.

3. The multimedia enrichment system according to claim 1, further comprising a graphic user interface coupled with said multimedia reproducer, for displaying a singing animation character.

4. A method for reproducing multimedia content associated with an audio stream of an interchangeable media, the method comprising the procedures of:
retrieving audio information from said interchangeable media, said audio information being associated with said audio stream, said audio information including authentication information respective of said audio stream;
determining authenticity of said audio stream according to said audio information;
retrieving said multimedia content from a database, if said audio stream is determined to be authentic; and
reproducing said multimedia content in synchrony with said audio stream.

5. The method according to claim 4 further comprising the procedures of:
determining a short segment from said audio stream, as an introduction segment for said audio stream, according to the length of said audio stream; and
playing back said segment.

6. The method according to claim 4 further comprising the procedures of:
determining the timing of each syllable, of each word, in said audio stream;
determining an animation position for a singing animation figure from said timing, and
displaying said singing animation character in synchrony with said audio stream.

7. The method according to claim 4 further comprising the procedure of:
allowing an independent content creator to add content to said database.
